(19) United States
(12) Patent Application Publication
(10) Pub. No.: US 2024/0237638 A1
(43) Pub. Date: Jul. 18, 2024

(54) USE OF NAPHTHALENE SULPHONATE AS COMPATIBILISER IN TANK MIX COMPOSITION

(71) Applicant: SPECIALTY OPERATIONS FRANCE, Lyon (FR)

(72) Inventors: Sumit Sharma, Werribee (AU); Ritu Ahuja, Singapore (SG); Renato Monterosso, Melbourne (AU)

(73) Assignee: SPECIALTY OPERATIONS FRANCE, Lyon (FR)

(21) Appl. No.: 18/554,368

(22) PCT Filed: Apr. 6, 2022
(86) PCT No.: PCT/EP2022/059136

§ 371 Date: Oct. 6, 2023

(30) Foreign Application Priority Data
Apr. 6, 2021 (WO) PCT/EP2021/058979

(51) Int. Cl. A01N 25/22; A01N 57/20; A01P 13/00

(52) U.S. Cl. CPC A01N 25/22; A01N 57/20; A01P 13/00

(57) ABSTRACT

The present invention relates to an agricultural tank-mix composition, comprising an agricultural active composition and a compatibiliser selected from naphthalene sulphonate or the formaldehyde condensates thereof.

### FIELD OF THE INVENTION

The present invention relates to an agricultural tank-mix composition, comprising an agricultural active composition and a compatibiliser selected from naphthalene sulphonate or the formaldehyde condensates thereof. The present invention further relates to the use of naphthalene sulphonate or the condensate thereof as compatibiliser in tank mix composition.

### BACKGROUND

For many purposes in agriculture and related endeavors it is desired to apply simultaneously two or more biologically active compounds, each of which is a pesticide or plant growth regulator, to the same locus. This is best accomplished by including the two or more compounds in a single composition which is applied, for example by spraying, to target plants or soil. Frequently such a composition is prepared by the user in the field by adding measured amounts of two or more concentrate compositions of the individual active ingredients to water in a spray tank, sometimes together with other ingredients. A composition prepared in this way is often known as a “tank-mix”.

Each formulated product has a set of complex chemical structures. As a result, each tank-mix partner increases the potential for incompatibilities, for example sedimentation or flocculation which can negatively affect spray application and effectiveness of crop protection products.

Naphthalene sulphonate or the condensate thereof is a commonly used dispersant for herbicidal formulation, for example, WO 19243994 A disclose that alkyl naphthalene sulphonate condensate can be used as in-built dispersant to improve the physical stability and/or dilution performance of the fungicidal composition comprising the same. Typically, in-built dispersant is in an amount ranging from 1 to 10 wt. % based on the total weight of the fungicidal composition, and will be diluted more than 200 times during the operation, higher amount of the in-built dispersant is avoided for the reason of saving cost or impairing formulation stability.

Therefore, there is still no technology available to identify/develop tank mix compatibiliser that reduces or eliminates the incompatibility issue.

### SUMMARY OF THE INVENTION

It was surprisingly found by the applicant naphthalene sulphonate or the formaldehyde condensate can be added to tank mix formulation on the purpose of improving compatibility thereof.

In one aspect of the present invention, it is provided agricultural tank-mix composition comprising an agricultural active composition and naphthalene sulphonate or the formaldehyde condensate as compatibiliser.

In another aspect of the use of naphthalene sulphonate or formaldehyde condensates thereof as compatibiliser to stabilize the agricultural active composition.

In still another aspect of the present invention, it is provided a process of preparing a tank mix composition, comprising the steps of mixing naphthalene sulphonate or formaldehyde condensates thereof as compatibiliser with an agricultural active composition.

### DETAILED DESCRIPTION OF THE INVENTION

Throughout the description, including the claims, the term “comprising one” or “comprising a” should be understood as being synonymous with the term “comprising at least one”, unless otherwise specified. The terms “between” and “from . . . to . . . ” should be understood as being inclusive of the limits.

The articles “a”, “an” and “the” are used to refer to one or to more than one (i.e., to at least one) of the grammatical object of the article.

It should be noted that in specifying any range of concentration, weight ratio or amount, any particular upper concentration, weight ratio or amount can be associated with any particular lower concentration, weight ratio or amount, respectively.

As used herein, the term “alkyl” means a saturated hydrocarbon radical, which may be straight, branched or cyclic, such as, methyl, ethyl, n-propyl, iso-propyl, n-butyl, sec-butyl, t-butyl, pentyl, n-hexyl, cyclohexyl.

As used herein, the terminology “(Cn-Cm)” in reference to an organic group, wherein n and m are each integers, indicates that the group may contain from n carbon atoms to m carbon atoms per group.

In one aspect of the present invention, it is provided an agricultural tank-mix composition, comprising:
a) an agricultural active composition comprises:
   a1) a glyphosate herbicide; and
   a2) at least one herbicide selected from isoxazolidinone herbicides, benzamide herbicides, chlorotriazine herbicides, dinitroaniline herbicides, or benzoic acids herbicide; and
b) a compatibiliser selected from naphthalene sulphonate or formaldehyde condensates thereof, wherein the naphthalene sulphonate is represented by the formula I and present in an amount of ranging from 0.1 to 5 wt. %, preferably 0.3 to 2 wt. %, more preferably from 0.2 to 1 wt. %, based on total weight of the agricultural tank-mix composition,

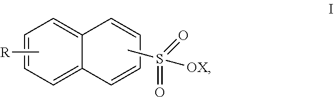

wherein R represents one or more substituents selected from C₁ to C₆ alkyl, M represents a cation selected from alkali metal, alkali earth metal, and ammonium.

The agricultural tank mix composition as provided in the present invention has improved compatibility on addition the naphthalene sulphonate or formaldehyde condensates thereof as compatibiliser, which in turn bring the benefit for example, but not limited to, no nozzle blockage, easy tank cleaning.

In the present invention, the agricultural tank-mix composition according claim 1, wherein the agricultural active composition comprises:
a1) a glyphosate herbicide; and
a2) at least one herbicide selected from isoxazolidinone herbicides, benzamide herbicides, chlorotriazine herbicides, dinitroaniline herbicides, or benzoic acids herbicide.

In the present invention, the glyphosate herbicide refers to glyphosate or the salts thereof. Glyphosate refers to N-(phosphonomethyl)glycine.

In some embodiment of the present invention, the glyphosate herbicide is selected from glyphosate.

In the present invention, glyphosate can be present in its acid form, as well as to glyphosate in the form of any water-soluble agriculturally acceptable salt or derivative thereof, which provides glyphosate acid or glyphosate anions in a solution of a herbicidal composition according to this invention.

Preferably the glyphosate herbicide employed herein is a relatively non-hygroscopic water-soluble glyphosate salt such as an alkali metal, for example sodium, salt, or ammonium salt of glyphosate or a mixture(s) thereof, although any salts of glyphosate which are able to be formulated in a water-soluble dry form, or mixtures of any such salts or a mixture of glyphosate acid and any such salts, may be employed if desired. Most preferred are mono alkali metal salts of N-phosphonomethylglycine and the mono ammonium salt of N-phosphonomethylglycine or mixtures thereof and the like.

In some embodiments, the glyphosate herbicide, particularly glyphosate, presents in the salt form selected from potassium (K) salt, sodium (Na) salt, isopropylamine (IPA) salt, monoethanolamine (MEA) salt, monomethylamine (MMA) salt, triethylamine (TEA) salt, dimethylamine (DMA) salt, trimethylsulphonium salt, and ammonium (NH₃) salt. Preferably the glyphosate herbicide is glyphosate potassium salt.

When the glyphosate herbicide is used in the form of an aqueous composition, the glyphosate concentration, notably loading, may vary widely, depending on the specific use intended. Typically the composition is in the form of an aqueous solution containing in the range of from 0.5 to 800 g/l glyphosate (ae, acid equivalent) and preferably from 5.0 to 700 g/l (ae). Concentrate compositions containing from 300 to 800 g/l (ae) are the most.

In some embodiments of the present invention, the isoxazolidinone herbicide is selected from bixlozone, clomazone or the combination thereof. Bixlozone refers to 2-[(2,4-dichlorophenyl)methyl]-4,4-dimethyl-3-isoxazolidinone. Clomazone refers to 2-(2-Chlorobenzyl)-4,4-dimethylisoxazolidin-3-one.

In some embodiments of the present invention, the chlorotriazine herbicides is selected from
6-chloor-N′-ethyl-N-propan-2-yl-1,3,5-triazine-2,4-diamine (atrazine);
2-Chloro-4-(1-cyano-1-methylethyl-amino)-6-ethylamine-1,3,5-triazine(cyanazine);
6-Chloro-N, N′-bis(1-methylethyl)-1,3,5-triazine-2,4-diamine (propazine);
6-Chloro-N, N′-diethyl-1,3,5-triazine-2,4-diamine (simazine) and
N-tert-butyl-6-chloro-N′-ethyl-1,3,5-triazine-2,4-diamine (terbuthylazine).

Preferably, the chlorotriazine herbicides is selected from simazine and terbuthylazine.

In some embodiments of the present invention, the dinitroaniline herbicide is selected from:
4-trifluoromethyl-2,6-dinitro-N, N-di-n-propylaniline (trifluralin);
4-trifluoromethyl-2,6-dinitro-N-n-butyl-N-ethylaniline (benefin);
4-trifluoromethyl-2,6-dinitro-N-ethyl-N-methallylaniline (ethalfluralin);
3,4-dimethyl-2,6-dinitro-N-(1-ethylpropyl)aniline (pendimethalin);
4-trifluoromethyl-2,6-dinitro-N-propyl-N-(2-chloroethyl)aniline (fluchloralin);
4-trifluoromethyl-2,6-dinitro-3-amino-N,N-diethylaniline (dinitramine);
4-sulfamoyl-2,6-dinitro-N, N-di-n-propylaniline (oryzalin); and
4-(methylsulfonyl)-2,6-dinitro-N,N-di-n-propylaniline (nitralin).

Preferably, the dinitroaniline herbicide is selected from trifluralin.

In some embodiments of the present invention, the benzoic acid herbicide is selected from:
3-amino-2,5-dichlorobenzoic acid (chloramben);
3,6-dichloro-2-methoxybenzoic acid (dicamba);
2,3,6-trichlorobenzoic acid (2,3,6-TBA); and
2,3,5-trichloro-6-methoxybenzoic acid (tricamba).

Preferably, the benzoic acid herbicide is selected from dicamba.

In one embodiment of the present invention, the component a2) is selected from the combination of chlorotriazine herbicide, benzoic acid herbicide, dinitroaniline herbicide which are illustrated as above.

In one embodiment of the present invention, the component a2) is selected from simazine, terbuthylazine or the combination thereof.

In one embodiment of the present invention, the component a2) is selected from propyzamide.

In one embodiment of the present invention, the component a2) is selected from Bixlozone.

In one embodiment of the present invention, the component a2) is selected from the combination of Simazine, Dicamba, and Trifluralin.

The herbicides as illustrated can be formulated in any formulation which is applicable in tank-mix application, for example including but not limited to emulsifiable concentrate (EC), soluble liquid (SL), suspension concentrate (SC) or water dispersable granule (WG or WDG).

In the present invention, the compatibiliser which can be used is selected from naphthalene sulphonate or formaldehyde condensates thereof, wherein the naphthalene sulphonate is represented by the formula I,

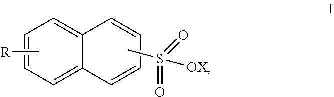

wherein R represents one or more substituents selected from H or C₁ to C₆ alkyl, M represents a cation selected from alkali metal, alkali earth metal, and ammonium.

In one embodiment of the present invention, R is selected from methyl, ethyl, propyl, and butyl, preferably selected from methyl.

In one embodiment of the present invention, M represents ammonium.

In one embodiment of the present invention, the compatibiliser is selected from naphthalene sulphonate formaldehyde condensate having a formula II

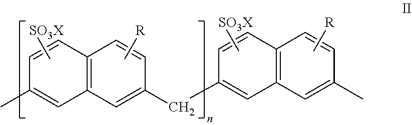

Wherein, R and X are defined as above, n is an integer ranging from 1 to 5.

In the present invention, the compatibiliser presents in the tank mix composition in an amount ranging from 0.1 to 5 wt. %, preferably 0.2 to 2 wt. %, more preferably from 0.3 to 1 wt. %, based on the total weight of the agricultural tank-mix composition.

In another aspect of the present invention, it is provided an use of naphthalene sulphonate or formaldehyde condensates thereof as compatibiliser to stabilize the agricultural active composition

In still another aspect of the present invention, it is provided a process of preparing a tank mix composition, comprising the steps of mixing naphthalene sulphonate or formaldehyde condensates thereof as compatibiliser with an agricultural active composition.

### EXAMPLES

### 1. Preparation of the Agricultural Tank-Mix Composition

The simulated ‘tank’ (graduated cylinder) was filled to 70% with 1000 ppm water. Naphthalene sulphonate formaldehyde condensate (CAS:9069-80-1, commercial available) was added as tank mix compatibiliser at 0.2 wt. %, based on the total weight of the tank mix composition. The formulations were then added, according to their type—WDG/WGs first, then SCs, ECs, SLs (non-glyphosate) and finally glyphosate SL. The cylinder was inverted 10 times every time new products were added to the ‘tank’. The ‘tank’ was made up to volume with 1000 ppm water and given a final 10 inversions prior to measurement start. All the herbicidal formulations are commercial available from the market.

### 2. The Compatibility Determination Process

Compatibility was determined by the amount of sedimentation after 2 hours and/or the presence of sedimentation on the sieve. That is, if the addition of the compatibiliser reduced the amount of sediment after 2 hours and/or reduced the presence of sedimentation on the sieve, it was deemed to be aiding in compatibility.

After 2 hours of static testing, the measuring cylinders were inverted 10 times before being passed through a 100 μm sieve. Sediment on the sieve was visually observed or weighed by volume, as well as any oily residue, crystals or inability for the liquid to pass through the sieve (if the sediment had blocked it completely).

The compatibility test result was listed in the table 1 as below. As shown by the table 1, the tank mix composition comprising the compatibiliser has improved compatibility over those without adding the compatibiliser.

TABLE 1
compatibility test results

| | | Rate L/ha in | Amount per | | composition | composition |
|---|---|---|---|---|---|---|
| | Herbicidal | 50 L of hard | 100 mL | | without the | with the |
| | formulations | water (1000 ppm) | (mL or g) | | compatibiliser | compatibiliser |
| Ex 1 | 570 g/l | 1.200 | L/ha | 2.4 | 20 mL | Trace/ |
| | Glyphosate | | | | sediment after | negligible |
| | potassium salt SL | | | | 120 minutes | retention on |
| | 875 g/kg | 1.400 | Kg/ha | 2.8 | | sieve |
| | terbuthylazine WG | | | | | |
| Ex 2 | 570 g/l | 0.625 | L/ha | 1.25 | 6 mL | Trace/ |
| | Glyphosate | | | | sediment after | negligible |
| | potassium salt SL | | | | 120 minutes, | retention on |
| | 900 g/kg | 0.35 | kg/ha | 0.7 | | sieve |
| | Propyzamide WG | | | | | |
| Ex 3 | 570 g/l | 0.625 | L/ha | 1.25 | 2.5 mL after | Trace/ |
| | Glyphosate | | | | 120 minutes | negligible |
| | potassium salt SL | | | | | retention on |
| | 500 g/L | 0.625 | L/ha | 1.25 | | sieve |
| | Propyzamide SC | | | | | |
| Ex 4 | 900 g/kg | 1.10 | kg/ha | 2.2 | 9.0 mL | Trace/ |
| | Simazine | | | | sediment after | negligible |
| | 570 g/l | 1.12 | L/ha | 2.24 | 120 minutes | retention on |
| | Glyphosate | | | | | sieve |
| | potassium salt SL | | | | | |
| | 750 g/l | 0.25 | L/ha | 0.5 | | |
| | Dicamba Amine SL | | | | | |
| | 480 g/L | 2.00 | L/ha | 4.00 | | |
| | Trifluralin EC | | | | | |

1. An agricultural tank-mix composition, comprising:
a) an agricultural active composition comprises:
a1) a glyphosate herbicide; and
a2) at least one herbicide selected from isoxazolidinone herbicides, benzamide herbicides, chlorotriazine herbicides, dinitroaniline herbicides, or benzoic acids herbicide; and
b) a compatibiliser selected from naphthalene sulphonate or formaldehyde condensates thereof, wherein the naphthalene sulphonate is represented by the formula I and present in an amount of ranging from 0.1 to 5 wt. %, based on the total weight of the agricultural tank-mix composition, 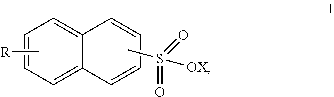
wherein R represents one or more substituents selected from C₁ to C₆ alkyl, M represents a cation selected from alkali metal, alkali earth metal, and ammonium.

2. The agricultural tank-mix composition according to claim 1, wherein the component a2) is selected from chlorotriazine herbicide, benzoic acid herbicide, dinitroaniline herbicide or the combination thereof.

3. The agricultural tank-mix composition according to claim 1, wherein the glyphosate herbicide is selected from glyphosate.

4. The agricultural tank-mix composition according to claim 1, wherein the glyphosate herbicide presents in the salt form selected from potassium (K) salt, sodium (Na) salt, isopropylamine (IPA) salt, monoethanolamine (MEA) salt, monomethylamine (MMA) salt, triethylamine (TEA) salt, dimethylamine (DMA) salt, trimethylsulphonium salt, and ammonium (NH₃) salt.

5. The agricultural tank-mix composition according to claim 1, wherein the glyphosate herbicide is in the form of an aqueous solution containing in the range of from 0.5 to 800 g/l (ae) glyphosate.

6. The agricultural tank-mix composition according to claim 1, wherein the isoxazolidinone herbicide is selected from bixlozone or clomazone.

7. The agricultural tank-mix composition according to claim 1, wherein the benzamide herbicide is selected from propyzamide.

8. The agricultural tank-mix composition according to claim 1, wherein the chlorotriazine herbicide is selected from atrazine, cyanazine, propazine, simazine and terbuthylazine.

9. The agricultural tank-mix composition according to claim 1, wherein the dinitroaniline herbicide is selected from trifluralin, benefin, ethalfluralin, pendimethalin, fluchloralin, dinitramine, oryzalin, or nitralin.

10. The agricultural tank-mix composition according to claim 1, wherein the benzoic acid herbicide is selected from chloramben, dicamba, 2,3,6-TBA, or tricamba.

11. A method comprising: stabilizing an agricultural active composition, wherein a naphthalene sulphonate or formaldehyde condensates thereof act as compatibiliser to stabilize the agricultural active composition comprising:
a) an agricultural active composition comprises:
a1) a glyphosate herbicide selected from glyphosate, glyphosine or glufosinate; and
a2) at least one herbicide selected from isoxazolidinone herbicides, benzamide herbicides, chlorotriazine herbicides, dinitroaniline herbicides, or benzoic acids herbicide;
wherein the naphthalene sulphonate is represented by the formula I and presents in an amount of ranging from 0.1 to 5 wt. %, based on the total weight of the agricultural tank-mix composition, 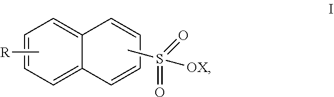
wherein R represents one or more substituents selected from H or C₁ to C₆ alkyl, M represents a cation selected from alkali metal, alkali earth metal, and ammonium.

12. A process of preparing a tank mix composition, comprising the steps of mixing naphthalene sulphonate or formaldehyde condensates thereof as compatibiliser with an agricultural active composition comprising:
a) an agricultural active composition comprises:
a1) a glyphosate herbicide selected from glyphosate, glyphosine or glufosinate; and
a2) at least one herbicide selected from isoxazolidinone herbicides, benzamide herbicides, chlorotriazine herbicides, dinitroaniline herbicides, or benzoic acids herbicide;
wherein the naphthalene sulphonate is represented by the formula I and present in an amount of ranging from 0.1 to 5 wt. %, based on the total weight of the agricultural tank-mix composition, 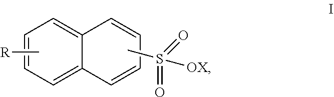
wherein R represents one or more substituents selected from H or C₁ to C₆ alkyl, M represents a cation selected from alkali metal, alkali earth metal, and ammonium.
